(19) United States
(12) Patent Application Publication
(10) Pub. No.: US 2016/0034948 A1
(43) Pub. Date: Feb. 4, 2016

(54) SYSTEM AND METHOD FOR FRACTIONAL ATTRIBUTION UTILIZING USER-LEVEL DATA AND AGGREGATE LEVEL DATA

(71) Applicant: Google Inc., Mountain View, CA (US)

(72) Inventors: Shi Zhong, Mountain View, CA (US); Robert Lee Marsa, Mountain View, CA (US)

(21) Appl. No.: 14/879,714

(22) Filed: Oct. 9, 2015

Related U.S. Application Data
(63) Continuation of application No. 14/056,918, filed on Oct. 17, 2013.
(60) Provisional application No. 61/770,957, filed on Feb. 28, 2013.

(51) Int. Cl. G06Q 30/02

(52) U.S. Cl. CPC G06Q 30/0246; G06Q 30/0201

(57) ABSTRACT

Embodiments provide fractional attribution using aggregate-level information as well as user-level data. For example, aggregate data may be used to determine marginal conversion probabilities for individual attributes within each channel. For channels that have user-level data, the marginal conversion probabilities may be determined using user-level data associated with converted users and aggregate-level data associated with non-converting users. Different channels may have different attributes and the channels may be weighted, in one embodiment, via a causal analysis using instrumental variables. Each conversion path may be characterized by a set of attributes. Additionally, each conversion path may have touch points. The marginal conversion probabilities for the attributes may be combined to produce an importance weight for each touch point on a converting path. These importance weights can be normalized across the touch points on the converting path to obtain attribution results.

### CROSS-REFERENCE TO RELATED PATENT APPLICATIONS

This application claims priority to and is a continuation of U.S. patent application Ser. No. 14/056,918, filed Oct. 17, 2013, which in turns claims priority to U.S. provisional application 61/770,957, filed Feb. 28, 2013, incorporated herein by reference in their entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates generally to the field of building advertising analytics platforms and specifically to the field of system, method and architecture for advertising conversion fractional attribution analysis, including scenarios in which user-level data may not be available for non-converting user paths.

### BACKGROUND

The modern advertising industry can take advantage of many channels for commercial messaging. These include traditional offline channels, such as direct mail, print, radio, and television, as well as a variety of online channels, like Web page advertising, search engine advertising, social media advertising, and email advertising.

Challenges exist in finding out more fair and correct credits each advertisement event deserves. Consequently, there is always room for innovations and improvements.

### SUMMARY

Marketers often need to determine the effectiveness of multiple advertising campaigns in terms of how much “conversion” credit advertisement event (thus each campaign/site/creative/channel) deserves. In this disclosure, a “conversion” refers to a desired activity, such as a user's purchase of an advertiser's product or service. This can be an issue, for example, if an ad buyer wants to determine a price for a direct buy, i.e., a direct interaction with an ad publisher, and also in the case of real-time bidding across sites.

A fractional attribution solution that leverages user-level data from online channels is described in the commonly-assigned, co-pending U.S. patent application Ser. No. 13/195,753, entitled “SYSTEM, METHOD AND COMPUTER PROGRAM PRODUCT FOR FRACTIONAL ATTRIBUTION USING ONLINE ADVERTISING INFORMATION,” which is fully incorporated by reference herein.

In some cases, user-level data may not be available. For example, for a direct mail advertising channel, it may be possible to tie converted direct mail users to their online events (i.e., an ad exposure) by matching information collected at conversion time such as registration forms, surveys, questionnaires, etc. to online user activities, for instance, via online cookies, etc. However, there is no way to track users who received/opened their mail but never converted. This example illustrates that it can be very difficult, if not impossible, to connect a non-converting user's offline touch points with the user's online touch points. Consequently, it can be difficult to ascertain the effectiveness or influence of an offline ad campaign on an online user's behavior.

The non-availability of user-level data may arise also for online channels such as social channels. For example, social networking sites such as Twitter may be willing to share more details about converted users but not details about everybody. Accordingly, a new approach and methodology is needed to properly assign fractional conversion credit to touch points.

In this disclosure, the term “touch point” (also referred to as touchpoint, contact point, or point of contact) refers to any encounter between a consumer and a business. For example, a listener heard an ad about a business on the radio. In this case, the radio represents an offline channel and the ad represents an offline advertising event occurring via the offline channel. Suppose this is the first time the listener encountered the business. This encounter represents an offline touch point. Suppose the listener then went online and visited a website of the business and, while there, made a purchase through the website. The listener's visit to the business's website represents an online touch point. Those skilled in the art will recognize that, whether it is offline or online, a channel can have numerous touch points.

Although it appears that the online touch point resulted in a conversion—the listener made a purchase through the website, in this example, the offline touch point is what caused the listener to visit the business's website in the first place. To be fair and accurate, then, the offline advertising event deserves some credit for the conversion—in other words, this particular conversion should ideally be fractionally attributed to the offline advertising event occurring in the offline channel.

Embodiments disclosed herein provide a system, method, and computer program product for fractional attribution using aggregate-level information as well as user-level data. In some embodiments, an attribution platform may have input data from one or more client computers and servers coupled to the platform. Input data may include one or more log files and/or impression and click data. An end user may be exposed to one or more advertising channels, e.g., he may receive directed e-mail advertisements, or may visit one or more Web sites or search engines having advertisements hosted by a client of the attribution platform. The end user may use a Web browser application running on a user device and may click on or otherwise convert (e.g., visit the advertiser's Web page, sign up for additional mailings, or make a purchase) upon exposure to one or more of the advertising channels.

Embodiments can leverage probabilistic modeling from aggregate-level data from non-converting users for each advertising attribute associated with an advertiser's advertising channel (e.g., campaign, site, placement, geo location, etc.) The conversion probabilities for each ad attribute are combined with channel-level weights from a separate aggregate-level regression model. This approach is driven by data in that the importance (which serves as the basis of calculating attribution fraction) of each advertisement event is derived based on data on both converted users and non-converting aggregate-level data.

The new fractional attribution approach is data-driven, without preconceived bias on the importance of different campaigns or sites. It is also a general approach that works with any number of different types of advertising campaigns, provided that user identification is tracked across different channels and thus data from different channels can be joined together to give a complete picture of user's interactions with the advertiser's advertising campaigns. This approach can be applicable to scenarios when user-level data are not available for non-converting users.

In some embodiments, a method for determining fractional attribution using user-level data and aggregate-level data may include determining, by a server computer using aggregate channel data within each channel of a plurality of channels, marginal conversion probabilities for individual channel attributes within each channel. The server computer may combine the marginal conversion probabilities to produce an importance weight for each touch point of a plurality of touch points on a converting path characterized by a set of attributes. The server computer may normalize these importance weights across the plurality of touch points on the converting path to obtain attribution results.

In some embodiments, an attribution method disclosed herein may be embodied in a computer program product comprising at least one non-transitory computer readable medium storing instructions translatable by at least one processor to perform the attribution method. In some embodiments, an attribution system may comprise software and hardware, including at least one processor and at least one non-transitory computer-readable storage medium that stores computer instructions translatable by the at least one processor to perform an attribution method disclosed herein.

Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 depicts a diagrammatic representation of an example user transaction in a network environment where embodiments disclosed herein may reside;

FIG. 2 depicts a diagrammatic representation of an example system architecture comprising multiple clients coupled to an attribution platform, implementing some embodiments disclosed herein;

FIG. 3 depicts an exemplary event tree according to some embodiments disclosed herein;

FIG. 4 is a flowchart illustrating attribution modeling according to some embodiments disclosed herein;

FIG. 5 is a table illustrating comparative results for fractional attribution and last event attribution according to some embodiments disclosed herein;

FIG. 6 is a plot diagram illustrating comparative differences by campaign for fractional attribution and other attribution methods according to some embodiments disclosed herein;

FIG. 7 is a table illustrating cost per conversions based on attribution results;

FIG. 8 is a flowchart illustrating a method for determining fractional attribution using user-level data and aggregate-level data;

FIG. 9 is a flowchart illustrating operation of embodiments; and

FIG. 10 is a table illustrating exemplary channel weighting.

### DETAILED DESCRIPTION

The disclosure and various features and advantageous details thereof are explained more fully with reference to the exemplary, and therefore non-limiting, embodiments illustrated in the accompanying drawings and detailed in the following description. Descriptions of known programming techniques, computer software, hardware, operating platforms and protocols may be omitted so as not to unnecessarily obscure the disclosure in detail. It should be understood, however, that the detailed description and the specific examples, while indicating the preferred embodiments, are given by way of illustration only and not by way of limitation. Thus, any examples or illustrations given herein are not to be regarded in any way as restrictions on, limits to, or express definitions of, any term or terms with which they are utilized. Instead these examples or illustrations are to be regarded as being described with respect to one particular embodiment and as illustrative only. Those of ordinary skill in the art will appreciate that any term or terms with which these examples or illustrations are utilized encompass other embodiments as well as implementations and adaptations thereof which may or may not be given therewith or elsewhere in the specification and all such embodiments are intended to be included within the scope of that term or terms. Language designating such non-limiting examples and illustrations includes, but is not limited to: “for example,” “for instance,” “e.g.,” “in one embodiment,” and the like. Various substitutions, modifications, additions and/or rearrangements within the spirit and/or scope of the underlying inventive concept will become apparent to those skilled in the art from this disclosure.

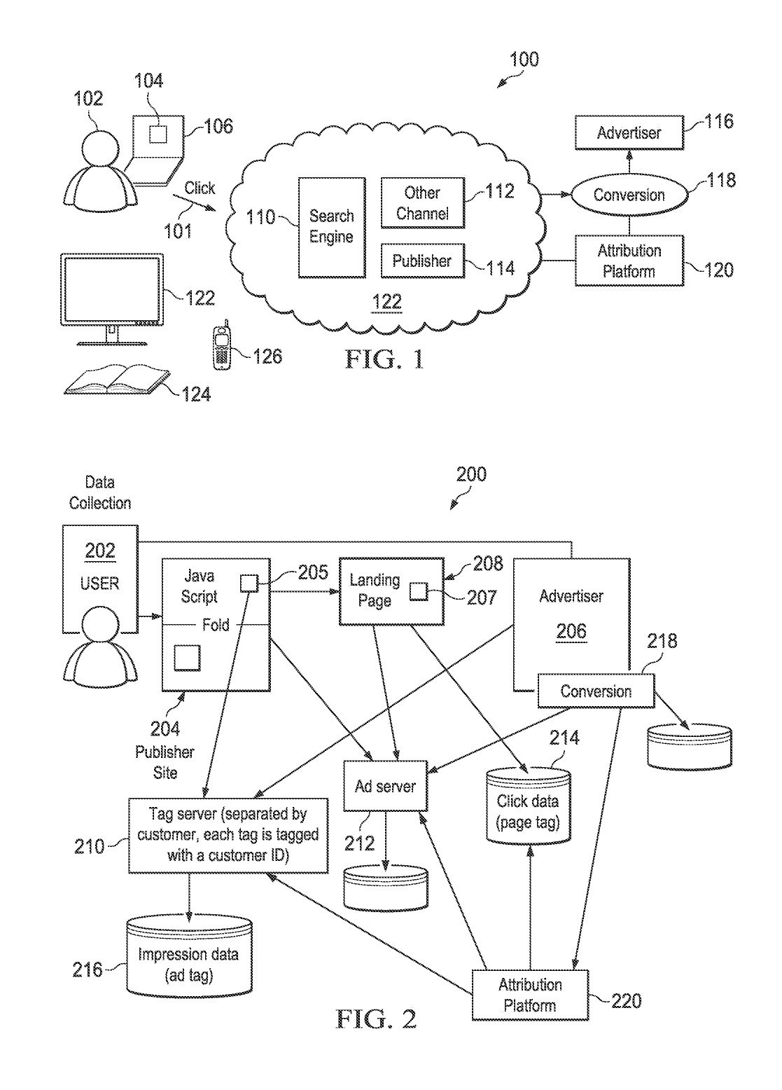

FIG. 1 depicts a diagrammatic representation of an example network environment for fractional cross-channel attribution.

In the example of FIG. 1, a user 102 may “convert,” or perform a desired action, after clicking a link 104 (e.g., a banner ad on a publisher web site 114, a search engine ad 110, or an ad on another channel 112), via a user device 106 at a particular Internet Protocol (IP) address and being directed via network 122 to the advertiser's web page 116. Conversion 118 can be a purchase transaction, but could also include such actions as registering with a Web site, signing up for product information, and the like. The conversion may occur after exposure to a commercial via television 122, print media 124, or radio 126.

An attribution platform 120 in accordance with embodiments of the invention allows the advertiser 116 to make informed decisions about payment for advertisements and future ad campaigns.

Data from the click 101 and ultimate conversion 118 may be collected in a variety of ways. In some embodiments, one or more computers in the network 122 may collect click data. In some embodiments, a click data collecting computer may be a server machine residing in a publisher 114's or other party's computing environment or network. In some embodiments, the click data collecting computer may collect click streams associated with visitors to one or more Web sites. In some embodiments, the collected information may be stored in one or more log files. In some embodiments, the information associated with the plurality of clicks may comprise visitor Internet Protocol (IP) address information, date and time information, publisher information, referrer information, user-agent information, searched keywords, cookies, and so on. For additional examples on collecting information provided from a visitor's Web browser application, readers are directed to U.S. patent application Ser. No. 11/796,031, filed Apr. 26, 2007, entitled “METHOD FOR COLLECTING ONLINE VISIT ACTIVITY,” which is fully incorporated herein by reference.

In some embodiments, the attribution platform 120 employs “ad tags” for monitoring impression data and “page tags” for monitoring click data. Ad tags can be 1×1 pixels embedded in page code at the publisher site and can be used to determine where the ad is on a page (above or below a “fold,” i.e., visible with or without scrolling) and whether and how long a user sees it. Page tags can be embedded in a similar manner on the landing page, and can identify whether a user has arrived and where the user comes from. Example tags are included in the attached Appendices A and B. As will be described in greater detail below, ad tags or page tags can be transmitted to the attribution platform 120 responsive to a user viewing or clicking on an ad and viewing or clicking on an associated web page.

In addition, in some embodiments, “aggregate” data may be provided or collected. For example, such aggregate data can include data from offline sources, such as television or radio ratings over predetermined periods, magazine and newspaper circulation on a per issue basis, and the like. In addition, in certain embodiments, user-level data from online sources may be “aggregated out” to correspond to similar data from offline sources. Examples of aggregate-level data include daily total impressions and click and conversion volumes by channel. External time series data such as consumer price index may also be leveraged, depending on the particular embodiment.

FIG. 2 depicts a diagrammatic representation of example system architecture 200 comprising one or more clients 202 and attribution platform 220. A user may browse a publisher site 204 which maintains one or more ad tags 205. Ad tag data can be sent to a tag server 210, responsive to a user viewing or clicking an ad, which stores in a database 216, impression data sorted by customer. Such data may include, e.g., where, when, and how long a user viewed the ad.

An ad server 212 may be used to maintain the ad on the publisher's web site 204. The user 202 may click an ad to arrive at a landing page 208. Embedded on the landing page 208 includes a page tag 207, which identifies user accesses to the landing page 208 and may be sent to a database 214 accessible by the attribution platform 220. An advertiser 206 records a conversion 218, if any, and likewise provides the information to the attribution platform 220.

Attribution platform 220 may reside in a computing environment comprising one or more server machines. Each server machine may include a central processing unit (CPU), read-only memory (ROM), random access memory (RAM), hard drive (HD) or non-volatile memory, and input/output (I/O) device(s). An I/O device may be a keyboard, monitor, printer, electronic pointing device (e.g., mouse, trackball, etc.), or the like. The hardware configuration of this server machine can be representative of other devices and computers alike at a server site (represented by platform 220) as well as at a client site.

Embodiments of platform 220 disclosed herein may include a system and a computer program product implementing a method for fractional attribution in a network environment. In some embodiments, platform 220 may be owned and operated independent of the clients that it services. For example, company A operating platform 220 may provide attribution services to company B operating a client (not shown). In one embodiment, Companies A and B may communicate over a network. In one embodiment, Companies A and B may communicate over a secure channel in a public network such as the Internet. Example clients may include advertisers, publishers, and ad networks.

In some embodiments, the system may run on a Web server. In some embodiments, the computer program product may comprise one or more non-transitory computer readable storage media storing computer instructions translatable by multiple processors to process attribution data. The input data may be from a log file, a memory, a streaming source, or ad and page tags. Within this disclosure, the term “attribution data” refers to any and all data associated with online advertising events such as clicking on an ad, viewing an ad (an impression), entering a search query, conversion, and so on, and may include click history data, click intelligence data, post-click data, visitor profile data, impression data, etc.

In some embodiments, software running on a server computer in platform 220 may receive a client file containing attribution data from an attribution data collecting computer associated with a client. For example, a client may represent an online retailer and may collect click stream data from visitors to a Web site own and/or operated by the online retailer. The attribution data thus collected can provide a detailed look at how each visitor got to the Web site, what pages were viewed by the visitor, what products and/or services the visitor clicked on, the date and time of each visit and click, and so on.

The specific attribution data that can be collected from each click stream may include a variety of entities such as the Internet Protocol (IP) address associated with a visitor (which can be a human or a bot), timestamps indicating the date and time at which each request is made or click is generated, target URL or page and network address of a server associated therewith, user-agent (which shows what browser the visitor was using), query strings (which may include keywords searched by the visitor), and cookie data. For example, if the visitor found the Web site through a search engine, the corresponding click stream may contain the referrer page of the search engine and the search words entered by the visitor. Attribution data can be created using a corporate information infrastructure that supports a Web-based enterprise computing environment. A skilled artisan can appreciate what typical attribution click streams may contain and how they are generated and stored.

Thus, in some embodiments, optimization data may include an impression/click record for every ad impression/click received from a given client of the system. An example impression/click record may include Impression/click timestamp; visitor cookie (if available, may be set up as a domain cookie for persistent visitor identification); visitor IP address; visitor browser user-agent; impression/click source (may be a publisher ID or a referrer domain); click destination (landing page Web address or bid keywords for advertisers); and conversion data (whether the visitor executed a desired conversion).

The optimization data returned from log files or tags may comprise one or more rows of data arranged in a plurality of fields. For example, in some embodiments, each row of event data includes twenty-three fields, defined as follows:
1. Server Timestamp, in YYYYMMddHHmmss format (UTC)
2. Request ID, generated by the server as a unique identifier for the logging call
3. Cookie ID. Omitted if the browser does not accept cookies.
4. Source IP
5. Interaction/Event Type
   <empty>=Old logs/tags did not specify an interaction type; this should be processed as an impression for those, but all recent data should process this as an error
   ?=Error condition—an invalid or unknown interaction type was specified. May indicate that an old parser is processing newer log files if there is a high frequency.
   0=Impression
   1=Click
6. Session ID—a number generated on page load by the browser and sent on all requests from that page (Impression, On Load, Post, etc.), used to correlate those events together. Populated in JavaScript tags only, 0 for pixel tags.
7. Campaign ID
8. Placement ID—may be an ID generated by us, if hard-coded in the tag, or the ad server placement ID, if populated by macro on the ad server.
9. Publisher ID—often not used (0)
10. Creative ID—rarely used (0), but may be used to indicate the creative.
11. Agency ID—often not used (0).
12. Visibility—1 if the tag is in an iFrame and visibility information cannot be collected. This prevents collection of ad seen and ad time data, as well as possibly indicating a “bogus” (ad server) referrer. Populated in JavaScript tags only.
13. Location on Page. Populated in JavaScript tags only.
   0=Banner (top 20%)
   1=Left Column (left 30%)
   2=Center Column (middle 40%)
   3=Right Column (right 30%)
   4=Below the fold
   5=Everything else (off right)
14. Ad Seen. 1 if the ad is not in an iFrame and was viewed at some point, captured by a JavaScript tag. Empty otherwise.
15. Screen resolution, Width×Height×Bit Depth; JavaScript tag only.
16. Time on Ad—the amount of time (seconds) the ad was scrolled into view in the client; only available from the JavaScript tag when not in an iFrame
17. Time on Page—the amount of time (seconds) the page was viewed; only available from the JavaScript tag
18. Source URL (URL encoded)—Best effort at finding the page URL. The JavaScript attempts to “climb out” of iFrames when possible to determine this, though sometimes the referrer must be used. The server component will attempt to extract the actual source URL from some known ad server referrers, if possible.
19. User Agent (URL encoded)
20. Demographic data. Pipe (“|”) delimited segments from the relevant demographic provider, as indicated by the interaction type.
21. Referrer URL (URL encoded)—The referrer of the page containing the tag, if available (i.e., not in a non-friendly iFrame and for the channel.js page tag); otherwise, the actual http referrer of the pixel/tag.
22. Revenue—if available (e.g., via Brighttag)
23. Custom (URL encoded)—any custom/unknown parameters specified on the http request, not otherwise handled. These take the form of ‘key1=value1; key2=value2; key3 . . . ’. An example of usage is to pass the custom field ‘checkout_rank=N’ through in this manner.

An exemplary event row is shown in Table 1 below:

TABLE 1

| column | value |
|---|---|
| 1 | 20130719180002 |
| 2 | Q212MzMxOGRIMjAxMzA3MTkxNDAwMDI3Mg== |
| 3 | C70d37a002013041209093840 |
| 4 | 12.43.117.146 |
| 5 | 4 |
| 6 | 903947 |
| 7 | 2118 |
| 8 | 63507 |
| 9 | 0 |
| 10 | 0 |
| 11 | 0 |
| 12 | 1 |
| 13 | |
| 14 | |
| 15 | |
| 16 | |
| 17 | |
| 18 | https%3A%2F%2Fwww.ideeli.com%2Flogin%3 |
| | Futm_campaign%3DDaily%26utm_medium%3Demail% |
| | 26utm_source%3Dideeli%26csync%3D1Mozilla%2F5.0+% |
| | 28Windows+NT+5.1%29+AppleWebKit%2F537.36+% |
| | 28KHTML%2C+like+Gecko%29+Chrome%2F28.0.1500.72+ |
| | Safari%2F537.36 |
| 19 | |
| 20 | https%3A%2F%2Fwww.ideeli.com%2Flogin%3 |
| | Futm_campaign%3DDaily%26utm_medium% |
| | 3Demail%26utm_source%3Dideeli |
| 21 | |
| 22 | |
| 23 | |

For the sake of simplicity, hardware components (e.g., CPU, ROM, RAM, HD, I/O, etc.) are not illustrated in FIG. 2. Embodiments disclosed herein may be implemented in suitable software code (i.e., computer instructions translatable by a processor). As one skilled in the art can appreciate, computer instructions and data implementing embodiments disclosed herein may be carried out on various types of computer-readable storage media, including volatile and non-volatile computer memories and storage devices. Examples of computer-readable storage media may include ROM, RAM, HD, direct access storage device arrays, magnetic tapes, floppy diskettes, optical storage devices, etc. As those skilled in the art can appreciate, the computer instructions may be written in any suitable computer language, including C++. In embodiments disclosed herein, some or all of the software components may reside on a single server computer or on any combination of separate server computers. Communications between any of the computers described above may be accomplished in various ways, including wired and wireless. As one skilled in the art can appreciate, network communications can include electronic signals, optical signals, radio-frequency signals, and other signals as well as combinations thereof.

It may be helpful to first describe a method for using event level or user level data for fractional attribution.

Without loss of generality, assume that a user has had three events (i.e., three interactions with a marketer's various campaigns; the definition of interactions is discussed below), prior to her conversion. The fractional attribution problem includes figuring out what fraction of the conversion credit goes each of the three events. A more mathematical description can be as follows:

If a user had events E₁, E₂, and E₃ and then converted, what fractional credit w₁ goes to E₁, w₂ goes to E₂, and w₃ goes to E₃, subject to Σⱼ₌₁³wⱼ=1?

In this example, it is assumed that the conversion event is 100% driven by the combination of the three events {E₁ E₂ E₃}. In reality this might not be true. However, it appears likely that whatever factors not observed introduce the same bias to all the campaigns in the data. The fractional attribution results are still useful in reflecting the relative importance of different channels/campaigns or of any other entities in which one might be interested.

In some embodiments, a good attribution model may possess three desirable properties: Monotonicity (Property 1); Correlation with Conversion (Property 2); and Accounting for Event Interactions (Property 3).

The first desired property is Monotonicity, which means that if two events (e.g., E₁ and E₂) were combined into one composite event E₁₂ then the fraction credit w₁₂ for E₁₂ should most likely be no less than w₁ or w₂. That is, w₁₂≧w₁ and w₁₂≧w₂. The intuition is that two events a converted user has with a marketer's campaigns should deserve no less credit than each of those two events individually.

The second property, Correlation with Conversion, holds that the weight for each event should be roughly correlated with the event's ability to drive conversions based on historical data. If E₁ historically has driven conversions better than E₂ and E₃ together, then E₁ deserves more credit than either E₂ and E₃.

The third property of the model should take into account as much as possible the interactions among different events. For example, if individually each of the three events has driven conversions equally well, but when E₂ and E₃ are together they have driven conversions much better, a higher credit weight should be given to either E₂ or E₃ than to E₁.

Let conversion be represented by C, in mathematical terms, this means If P(C|E₁)≅P(C|E₂)≅P(C|E₃) but P(C|E₂, E₃)>>P(C|E₁), then w₂>>w₁ and w₃>>w₁.

Embodiments make use of data-driven probabilistic models. That is, all the conditional probability estimates discussed herein are based on historical data.

In particular, each conditional probability P(A|B) can be derived from historical data by dividing the number of users who (at least) had events A and B by number of users who (at least) had event B. That is,

$$P ( A \vert B ) = \frac{\# users with events A and B}{\# users with event B} .$$

Embodiments may make use of any of a variety of models, although some may be more or less desirable, depending on the nature of the data.

A first model (Model 1) may be the Naïve Bayes model:

Consider the naïve Bayes model for P(C|E₁, E₂, E₃):

P(C|E₁,E₂,E₃)∝P(C|E₁)·P(C|E₂)·P(C|E₃). (1)

One natural idea would be to use

wⱼ=P(C|Eⱼ),j=1,2,3. (2)

This naïve choice does possess Properties 1 and 2 discussed above. However, this model assumes that the three events {E₁, E₂, E₃} are independent given the conversion event C. It does not return the right answer when there are strong event correlations; that is, it does not possess Property 3. For example, in the example used for explaining Property 3, this model would NOT give a higher weight to either E₂ or E₃ than that to E₁, which is desired.

A second model (Model 2) may be the Conversion Index model:

If w₁ is set to be the conversion index of E₁

$${w}_{1} = \frac{P ( C \vert {E}_{1} )}{P ( C \vert {\overline{E}}_{1} )} ∝ \frac{( 1 - P ( {E}_{1} ) ) \cdot P ( C \vert {E}_{1} )}{P ( C ) - P ( {E}_{1} ) \cdot P ( C \vert {E}_{1} )} , \qquad ( 3 )$$

where Ē₁ means “no event E₁”. This model turns out to be very similar to the naïve Bayes model because w₁ in (3) is strongly positively (although nonlinearly) correlated with P(C|E₁). As in the naïve Bayes model, correlations among the three events are not taken into account.

A third model (Model 3) may be the Conditional Importance model:

Consider capturing the importance E₁ by the conditional probability

$$\begin{matrix}{w}_{1} = P ( {E}_{1} \vert {E}_{2} , {E}_{3} , C ) \\ = \frac{P ( {E}_{1} , {E}_{2} , {E}_{3} , C )}{P ( {E}_{2} , {E}_{3} , C )} \\ ∝ \frac{1}{P ( {E}_{2} , {E}_{3} , C )} \\ ∝ \frac{1}{\# users with \{ {E}_{2} , {E}_{3} , C \}} ,\end{matrix} \qquad ( 4 )$$

which indicates how likely E₁ is observed, given that {E2, E3, C) are observed. However, with (4), w₁ may change in the wrong direction when the specificity of E₁ is increased. For example, if (4) were used to compute the importance of a composite event E₁₂={E₁, E₂}, the result would be

$${w}_{12} ∝ \frac{1}{\# users with \{ {E}_{3} , C \}} ,$$

which will most likely be smaller than w₁, even though according to Property 1 one would normally expect the opposite (w₁₂>w₁), i.e., the composite event E₁₂ should most likely get more conversion credit, not less.

A fourth model (Model 4) may be the Marginal Importance model:

Consider an improvement of Model 3 as follows

$${w}_{1} = \frac{P ( {E}_{1} \vert {E}_{2} , {E}_{3} , C )}{P ( {E}_{1} \vert {E}_{2} , {E}_{3} )} = \frac{P ( C \vert {E}_{1} , {E}_{2} , {E}_{3} )}{P ( C \vert {E}_{2} , {E}_{3} )} ∝ \frac{1}{P ( C \vert {E}_{2} , {E}_{3} )} . \qquad ( 5 )$$

This normalizes the probability of seeing E₁ given {E₂, E₃, C} in (4) by the probability of seeing E₁ given {E₂, E₃}. The idea is that, if E₁ is equally likely with or without C (given {E₂, E₃}), then it is probably not that important. Also what it means is that if E₂ & E₃ together drive conversions as well as all three events together, i.e., P(C|E₂, E₃) is close to P(C|E₁, E₂, E₃), then E₁ is probably not that important and the weight for E₁ should be small.

This new importance measure does not have the issue of Model 3 as the composite event E₁₂={E₁, E₂} would have an importance weight most likely higher than w₁ or w₂ alone. It can be imagined that

$${w}_{12} ∝ \frac{1}{P ( C \vert {E}_{3} )}$$

is most likely higher than w₁ as it is most likely that P(C|E₃)<P(C|E₂, E₃). Again the intuition here is that normally for a given user, the more he is advertised to, the more likely he is to convert.

This model also addresses the issue of not considering event interactions (as mentioned for Model 1&2). Suppose E₁ & E₂ together is effective and drives a high P(C|E₁, E₂) but it is not the case for P(C|E₁, E₃) and P(C|E₂, E₃), it can be seen that based on (5) E₁ & E₂ will each get more credits than E₃.

A variant of Model 4 can be

$${w}_{1} = \frac{P ( {E}_{1} \vert {E}_{2} , {E}_{3} , C )}{P ( {E}_{1} \vert {E}_{2} , {E}_{3} , \overline{C} )} ∝ \frac{1 - P ( C \vert {E}_{2} , {E}_{3} )}{P ( C \vert {E}_{2} , {E}_{3} )} \qquad ( 6 )$$

This weight becomes zero when P(C|E₂, E₃)=1.

Overall, the Marginal Importance model in (5) may provide better results than the other models discussed and possesses the three desired properties proposed above.

To generalize to the situation in which there are there are more than three events, say a converted user had K events, {E₁, E₂, . . . , E_{K}}, the credit weight for Eⱼ(j=1, . . . , K) would be

$$\begin{matrix}{w}_{j} ∝ \frac{1}{P ( C \vert \{ {E}_{1} , {E}_{2} , … , {E}_{K} \} \backslash {E}_{j} )} \\ ∝ \frac{\# all users with \{ {E}_{1} , {E}_{2} , … , {E}_{k} \} \backslash {E}_{j}}{\# converted users with \{ {E}_{1} , {E}_{2} , … , {E}_{K} \} \backslash {E}_{j}} ,\end{matrix}$$

where {E₁, E₂, . . . , E_{K}}\ Eⱼ means the subset of {E₁, E₂, . . . , E_{K}} without Eⱼ.

The definition of events may vary from implementation to implementation. For example, E₁ could represent a user seeing one or more impressions from a specific campaign; or a user seeing one or more impressions from a specific campaign more than two weeks ago; or a user seeing exactly two impressions from a specific campaign in the last day; or a user seeing one or more impressions on a specific site in the last day; etc.

As can be appreciated, the list of possible definitions can quickly become intractable. The question is which definitions make more sense than others for a particular implementation and how to combine attribution results if one were to run attribution analysis with different event definitions.

It may be desirable to define an event as specifically as possible; e.g., a user seeing exactly n impressions from campaign x with creative y on site z exactly m days ago. However, defining events at that deep level of granularity may encounter data sparsity—often there is not enough data to robustly derive the conditional probabilities described in the previous section. It may sound counterintuitive as the system easily collects billions of impressions and hundreds of millions of users every month from a large advertiser. However, not many users would share the same event of “seeing exactly n impressions from campaign x with creative y on site z exactly m days ago”. When the number of users is small, there would be low confidence in the conditional probabilities estimated.

To increase confidence levels, one can define events at a less granular level such as the campaign level. There are likely a lot of (both converted and non-converting) users sharing the event of “seeing at least one impression from campaign x”, making the estimates at campaign level more robust. However, if there are only estimates at the campaign level, it does not help to attribute conversion credits across different sites, different frequency or recency values for the same campaign.

In some embodiments, an attribution analysis may be run at many different granularity levels and then combined based on confidence values of different estimates. One technique for this task is “hierarchical Bayesian shrinkage.” The goal is to get as robust as possible an estimate at the most granular level. One way to address data sparsity at the granular level is to borrow information (or estimates) from lower granularity levels.

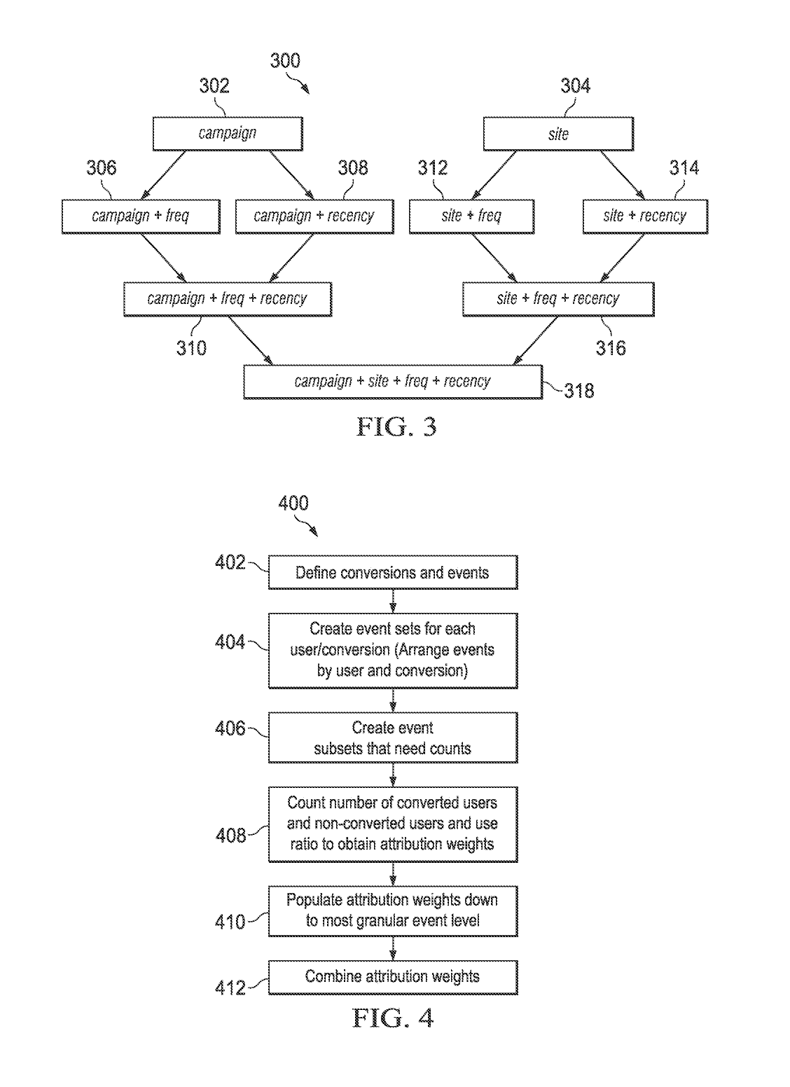

In some embodiments, different levels can be arranged into a hierarchy 300 like the one shown in FIG. 3. In particular, shown are parent nodes campaign 302 and site 304. Campaign node 302 is less granular and a parent to the nodes at the next most granular level, campaign+frequency 306 and campaign+recency 308. The nodes 306, 308 in turn are parents to node 310 (campaign+frequency+recency).

Likewise, parent node site 304 is parent to site+frequency 312 and site+frequency node 314 which, in turn, are parents to site+frequency+recency node 316. Nodes 310 and 316 are parents and less granular than node 318 (campaign+site+frequency+recency).

The attribution weight for a given event can be calculated for every node in the hierarchy and combined based on the confidence of each calculation. Confidence can be a function of the amount of data (i.e., the number of users) used to estimate the conditional probabilities. For example, a reasonable confidence function is the sigmoid function

$$g ( n ) = \frac{1}{1 + e - ( \frac{n - μ}{α} )} ,$$

where n is the number of users, and μ and α are adjustable parameters. The parameter, u determines when confidence becomes 0.5 and α controls how fast the confidence grows with n.

One way of combining the attribution weights estimated at different granularity levels is to take a confidence-weighted average across different levels. That is,

Σₗgₗwₗ/Σₗgₗ,

where w₁ is the attribution weight at level 1 and gₗ is the confidence at level 1. This effectively shrinks the (less robust) estimate at the most granular level towards (more robust) estimates at less granular levels, thus the name of “shrinkage”. In statistical terms, it is a tradeoff between bias and variance. At more granular levels, the estimates have lower bias but higher variance; at less granular levels, the estimates have lower variance (i.e., more robust) but higher bias. It will be appreciated that the actual equation may vary somewhat from implementation to implementation. For example, one embodiment may add a level-dependent weight that is fixed for each level to reflect prior knowledge about the importance of difference levels. That is, if enough data can be had at a campaign+recency level, one might want to give more weight to that level than to a less granular (e.g., campaign) level.

FIG. 4 is a flowchart illustrating operation of embodiments of the invention for generating fractional attribution results.

In a step 402, conversions and events are defined. As noted above, in some embodiments, a conversion is a desired activity, such as a user purchase of an advertiser's product or service. An event can be one or more user-defined events or sequences of events.

In a step 404, for each event definition (i.e., a particular granularity level), event sets for each user/conversion are created. This is essentially to arrange events by user and conversion. For each incidence of the conversion, this step may include listing all the event item exposures the user had prior to the conversion. Events are defined and tracked from the raw impression/click/conversion data obtained from the ad tags and page tags or log files or other data collected.

In a step 406, for each event definition, create event subsets that need counts. That is, for each event set of size K (that associates with a conversion), generate K−1 event subsets as explained above.

In a step 408, for each event definition, and for each event subset generated, count the number of converted users and number of non-converting users and use the ratio between those two as the basis for computing attribution weights. The total user counts may also be used as the basis for computing confidence as described above.

In a step 410, for each event definition, populate the attribution weights down to the most granular event level, i.e., individual impressions or clicks. Depending on the event definition, each event may map to one or more impressions/clicks and the attribution weight computed for the event will be evenly distributed down to individual impressions/clicks. For example, if events are defined by a campaign+recency, an event (campaign x+3 days ago) gets a weight of 0.6 and it corresponds to 10 impressions on that day, then each of those 10 impressions would get a weight of 0.06.

Finally, in a step 410, combine the attribution weights from different event definitions (i.e., different granularity levels) using, for example, the hierarchical Bayesian shrinkage method described above.

In some embodiments, step 406—getting the user counts for each event subset—is computationally intensive. There can be hundreds of millions of users and hundreds of thousands of subsets. Each user is represented by an event set (all the events the user has had). The basic operation includes, for each user and each subset, determining if the user's event set contains the subset of interest (for which user counts are wanted).

One efficient way of doing the counting is to determine, for each user, which n events he has seen, and to define (n−1) subsets. For example, if he has seen events E1, E2, E3, then the subsets are defined as follows:

S1 E1, E2

S2 E1, E3

S3 E2, E3

For each event in any of the subsets, keep track of the list of the indexes of the subsets that contain the item.

Then, for each user, go through each event in the user's event set and add all the subset indexes to a hash and keep track of the counts. For example, for event E1, add the subset indexes of S1 and S2 to a hash; for event E2, add the subset indexes of S1 and S3 to a hash; and for event E3, add the subset indexes of S2 and S3 to a hash. If the hash count of a subset index equals the length of the subset, increase the user count for a subset.

These steps can be performed for both converted users and non-converting users, separately, to obtain the counts. Further, these steps can be easily parallelized in practice.

An additional simplification may be made by noticing that most of the users are non-converting users. As such, a sample of the non-converting users may be taken to reduce the computation. Experiments have shown that using a 10% sample of non-converting users seems to generate roughly the same attribution weights vs. using all users' data.

The process of shortcut counting of converting and nonconverting users is shown below by way of an eight event example:

Shown in Table 2 below are exemplary event data (each row in this example is a user event sequence; E₁-E₈ are eight events to be assigned conversion credits; C/NC stands for conversion/no conversion):

TABLE 2

E₁E₂E₃ → C
E₁E₂E₅ → NC
E₃E₄E₅ → C
E₁E₃E₄E₅ → NC
E₁E₂E₆ → C
E₃E₄E₅E₆ → NC
E₁E₅E₆E₇ → C
E₁E₂E₄E₆E₇ → NC
E₂E₃E₄E₇ → NC
E₁E₂E₃E₅E₇ → NC
E₁E₃E₅E₆E₈ → NC
E₂E₆ → NC

For each converted user, generate all leave-one-out sub-sequences. For example, from the first converted user, one gets {E₁E₂}, {E₂E₃}, and {E₁E₃}.

Next, merge the sub-sequences from all converted users. For example, from the four converted users, one gets the following 12 sub-sequences, where the second column is an index assigned to the sub-sequences. This is shown in Table 3 below.

TABLE 3

{E₁E₂}, 1
{E₂E₃}, 2
{E₁E₃}, 3
{E₃E₄}, 4
{E₄E₅}, 5
{E₃E₅}, 6
{E₁E₆}, 7
{E₂E₆}, 8
{E₁E₅E₆}, 9
{E₁E₅E₇}, 10
{E₁E₆E₇}, 11
{E₅E₆E₇}, 12

For each sub-sequence S, count the number of converted users (n_{conv}) and number of non-converting users (n_{nonconv}) that have the sub-sequence and compute the +I conditional probability

$$P ( C \vert S ) = \frac{{n}_{conv + 1}}{{n}_{conv + {n}_{nonconv + 2}}}$$

(the extra count 1 and 2 added to the numerator and denominator are priors used to smooth out estimate from very sparse data).

To get the counts (n_{conv}) and (n_{nonconv}), do the following:
For each event, build an inverted index for each event that appeared in any converted user sequence, which stores the indexes of the sub-sequences that contain the event. This is shown in Table 4 below.

TABLE 4

E₁ → {1, 3, 7, 9, 10, 11}
E₂ → {1, 2, 8}
E₃ → {2, 3, 4, 6}
E₄ → {4, 5}
E₅ → {5, 6, 9, 10, 12}
E₆ → {7, 8, 9, 11, 12}
E₇ → {10, 11, 12}

For each user sequence in Table 2, use the inverted index to determine which sub-sequences in Table 3 are subsets of the user sequence, i.e., for which sub-sequences one should increment n_{conv} and/or n_{nonconv}. That is, for the first converted user sequence {E₁ E₂ E₃→C}, generate the following list (see Table 5 below) from the inverted index Table 4: {1,3,7,9,10,11; 1,2,8; 2,3,4,6} and then the sub-sequence counts (number of times appearing in the list):

TABLE 5

```
  1:2 ✓
  2:2 ✓
  3:2 ✓
  4:1 x
  6:1 x
  7:1 x
  8:1 x
  9:1 x
10:1 x
11:1 x
```

where the last column indicates whether each sub-sequence is a subset of the user sequence (by comparing the counts in the second column to the length of the sub-sequence; e.g., sequence 1 has a count of 2 in Table 5 and a length of 2 as seen in Table 3). Therefore, by going through, the user sequence {E₁E₂E₃→C}, it was determined that one should increase n_{conv} for sub-sequence 1, 2, and 3.

Results from operation of attribution modeling according to some embodiments will be discussed by way of example below.

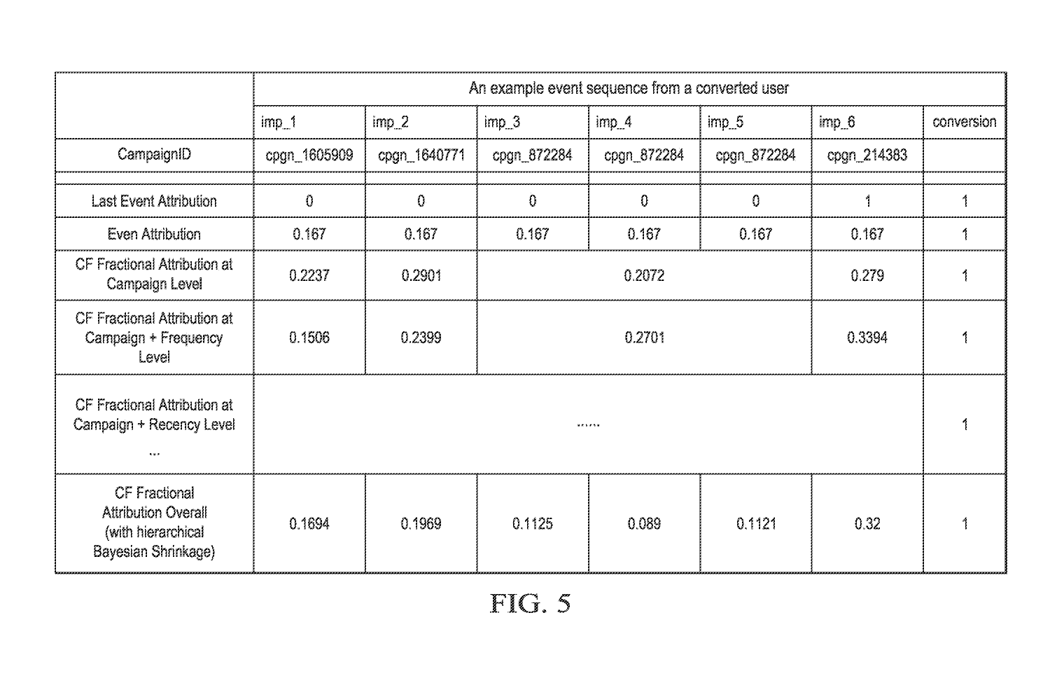

FIG. 5 shows attribution weights for a particular user with six impression events before a conversion. The six impressions (imp_{—}1, imp_{—}2, . . . , imp_{—}6) are arranged in temporal order. The last-click model assigns all credit to imp_{—}6 whereas an even attribution model assign 1/6 credit to each of the six events. The next two rows show the results of fractional attribution model at campaign level and campaign+frequency level, respectively. In this case, there are four event items for both of those levels but the weights are different as one takes into account frequency in the event definition and the other does not.

For simplicity, results for many other levels are omitted and in the last row the final fractional attribution results based on applying hierarchical Bayesian shrinkage to combine the results from all different levels are shown.

After this is done for every conversion, the result is a weight for each impression/click event (i.e., at the most granular level). These final weights can then be rolled up along different dimensions for reporting. Common dimensions of interest include campaign, site, creative, etc.

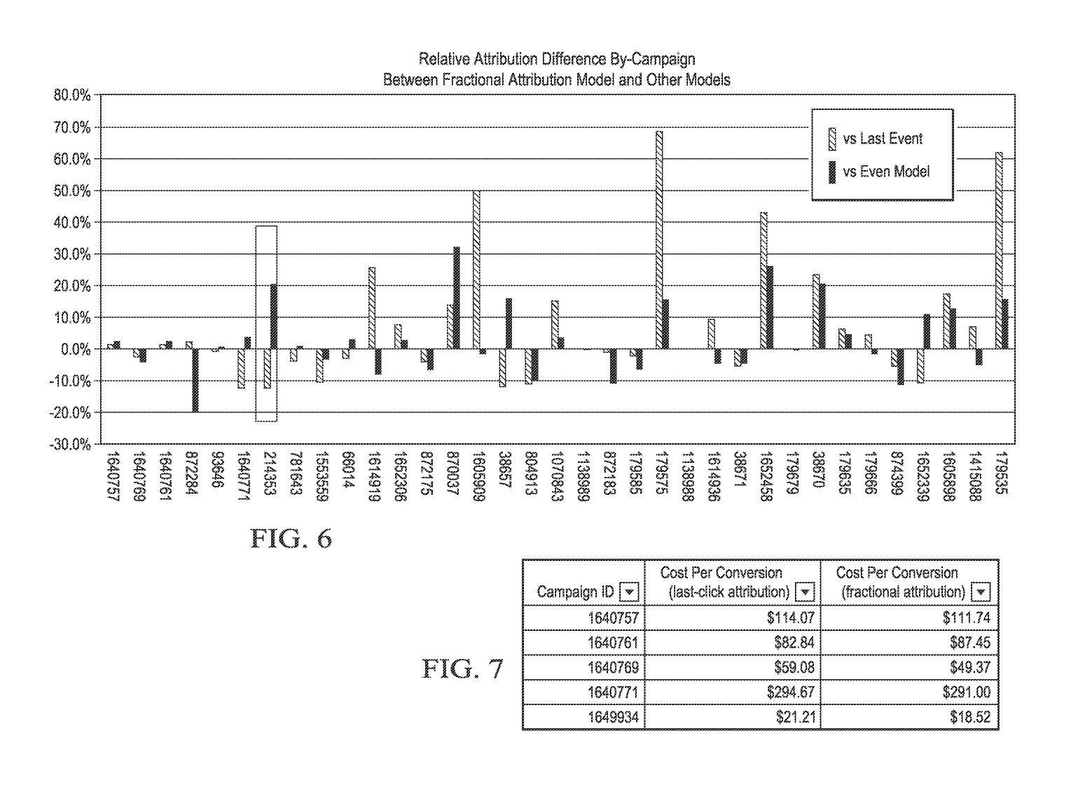

FIG. 6 compares the fractional model with the last-click model and even attribution model, after rolling up the attribution weights to campaign level. Campaign IDs are shown on the x-axis and relative difference between models on the y-axis. For example, for campaign ID 214383 (highlighted in the box), the fractional attribution model assigns to it 12% less credit than last-click model does, but 20% more than even model does.

FIG. 7 shows some examples of the cost per conversion metrics based on attribution results. In accordance with embodiments of the invention, the cost numbers based on fractional attribution models will be more accurate and can help make better business decisions regarding whether to increase or decrease spend on a particular campaign.

As noted above, in some cases, event level data is not available. That is, for some channels, only aggregate-level data is available. In such instances, it may still be desirable to assign fractional attribution across channels. In the case of a web site, for example, aggregate level data would be information indicating that on a particular day, the site delivered a particular ad to a particular number of users. In other cases, only some user level data is available.

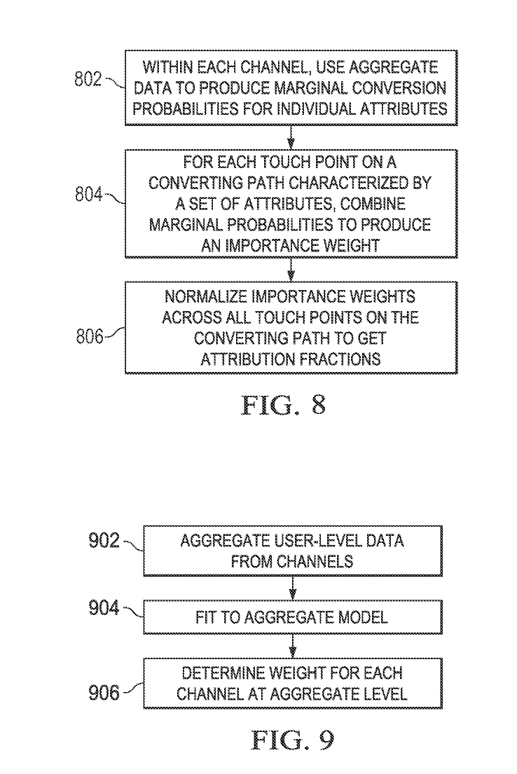

Turning now to FIG. 8, a flowchart illustrating a method for determining fractional attribution using user-level data and aggregate-level data according to an embodiment is shown. Within each of a plurality of channels (online and/or offline), aggregate data may be used to produce marginal conversion probabilities for individual attributes (step 802). These marginal probabilities may be combined to produce an importance weight for each touch point on a converting path characterized by a set of attributes (step 804). Various combining mechanisms can be used. The importance weights can then be normalized across all touch points on the converting path (step 806). The normalized importance weight represents the conversion fraction attributed to each touch point. Finally, attribution results (e.g., conversions attributed to each touch point and/or channel) may be reported.

Depending on the channel, different attributes may be of importance in conversions. For example,
Display: Campaign, site, placement, creative, geo, recency
Search: Campaign, KW Group, KW category, keyword, recency
Email: Campaign, recency
Social Media: Campaign, facebook/tweet event type
TV: Channel, program, telecast, ad copy, geo
Direct Mail: Campaign, list, recency

For each value of a particular attribute, embodiments compute a marginal conversion probability:

$$P ( conv \vert campaign = v 1 ) = \frac{total\_conv \_users \_for \_v 1}{total\_reached \_users \_for \_v 1}$$

This can, in some embodiments, be computed without detailed user-level data. For example, for all possible attributes {Aⱼ}, embodiments compute P(C|Aⱼ) using aggregate data. For a touch point on a converting path (event E₁), let there be three attributes A₁, A₂, and A₃ associated with it

P₁=P(C|A₁),P₂=P(C|A₂),P₃=P(C|A₃)

The marginal conversion probabilities may be combined to get an event importance weight

w(E₁)=f(P₁P₂P₃).

There can be different combining mechanisms, as defined by the function f( ). For example, one embodiment can use the naïve Bayes model discussed above.

After getting event importance weight for each touch point on a converting path w(E₁), w(E₂), . . . , w(Eₙ), the weights may be normalized to sum up to 1 and the normalized weight represents or becomes the conversion fraction attributed to each touch point.

In some embodiments, channel weighting may be used in determining event importance weights. Turning now to FIG. 9, a flowchart illustrating operation of an embodiment is shown. Initially, digital channels that have user-level data can be aggregated out into aggregate form (step 902). Alternatively, offline channels with only aggregate level data can be ascertained. Next (step 904), the channels can be fit to an aggregate model, such as an aggregate-level regression model. Finally, each channel can be given a weight at the aggregate level (step 906).

A regression modeling approach can be used to build a predictive model that can predict total (multi-channel) conversions, based on channel volumes. According to embodiments, a what-if analysis to produce a “delta key performance indicator (KPI)” that can be attributed to a given channel. In particular, the what-if analysis sets the volume for a channel to 0 and uses the delta change in predicted conversions as a measure of the conversion contribution from the channel. The deltas may be normalized across all channels to get a channel weight.

That is, delta KPI=predicted KPI (with all channels)—predicted KPI (without [what-if] channel).

An exemplary regression model that may be used is provided below:

x₀ is length of time period (e.g., # days)
{xᵢ}_{i=1, . . . , m} are volumes for different channels/placements
{w,α,β} are non-negative parameters of the non-linear regression model that are designed to capture interactions between each channel/placement and the KPI and among channel/placements.
Then, the predicted KPI, ŷ, is given by:

$$\hat{y} = {w}_{0} \cdot {x}_{0} + {\sum }_{k = 1}^{m} {w}_{k} \cdot g ( {a}_{k} {x}_{k} ) + {w}_{m + 1} \cdot g ( {\sum }_{k = 1}^{m} {β}_{k} {x}_{k} )$$

$$g ( x ) = \frac{1 - exp ( - x )}{1 + ex ( - x )}$$

Here, w₀·x₀ captures the baseline; g(αₖxₖ) captures channel-specific values; and g(Σₖ₌₁^{m}βₖxₖ) captures interactions.

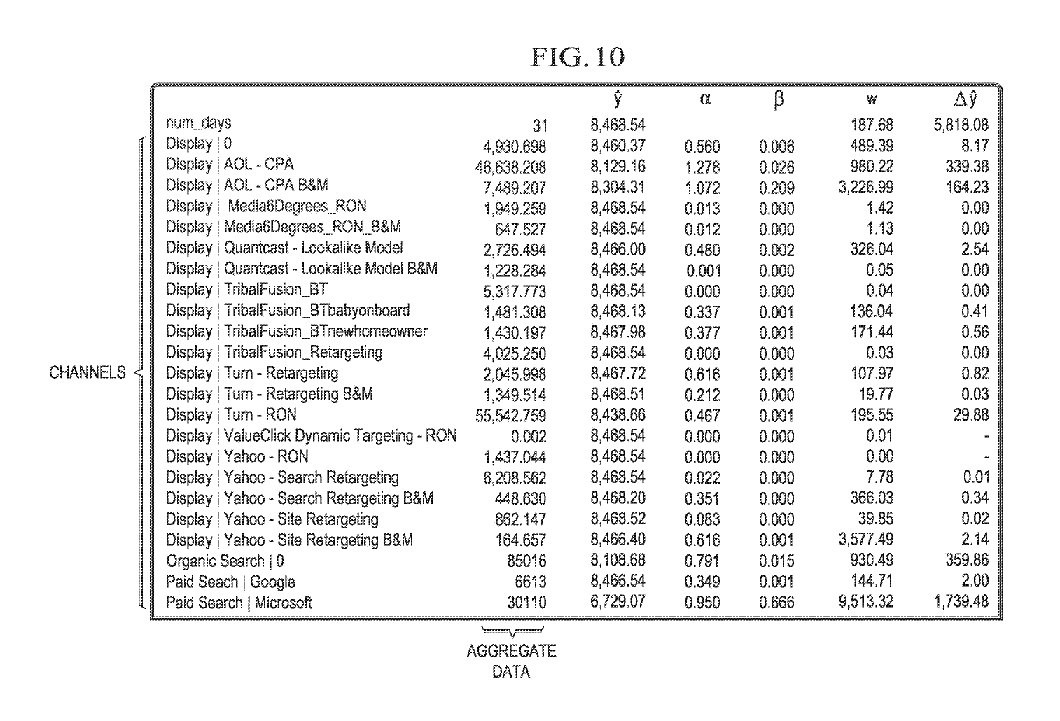

FIG. 10 shows example values for the w, α, and β parameters, the predicted KPI (ŷ), and the delta KPI (Δŷ) determined using data from a number of channels over a one month (31 day) period.

Table 6 below illustrates exemplary aggregate level data that may be used in conjunction with embodiments. In this example, Table 6 shows the KPI for data in predetermined periods (i.e., one week) for TV volume, Display volume, and Paid Search volume.

TABLE 6

| Week | | Period length | TV Volume | Display | Paid Search |
|---|---|---|---|---|---|
| Index | KPI | (x0) | (x1) | volume (x2) | volume (x3) |
| 1 | 1641 | | 2151449000 | 16804027 | 301862 |
| 2 | 1550 | | 1324139000 | 17105960 | 295913 |
| 3 | 1756 | | 1752262000 | 26227548 | 431713 |
| 4 | 1674 | | 1604994000 | 21903751 | 223286 |
| 5 | 1919 | | 1984001000 | 21154248 | 204708 |
| 6 | 1646 | | 1104399000 | 9013703 | 155295 |
| 7 | 2230 | | 664204000 | 8747002 | 142544 |
| 8 | 917 | | 1994760000 | 8721300 | 127959 |
| 9 | 2095 | | 2133997000 | 17462143 | 203469 |
| 10 | 2005 | | 2187959000 | 19622518 | 183965 |
| 11 | 1817 | | 1629374000 | 15305965 | 195570 |
| 12 | 839 | | 1066385000 | 7120515 | 110342 |
| 13 | 1219 | | 731298000 | 6230122 | 49386 |
| 14 | 3061 | | 1075845000 | 30407220 | 298963 |
| 15 | 2872 | | 1954760000 | 37775621 | 324554 |
| 16 | 2435 | | 1460215000 | 33495246 | 296442 |
| 17 | 2429 | | 2508148000 | 25601200 | 185078 |
| 18 | 1801 | | 2816486000 | 25195267 | 360340 |
| 19 | 1238 | | 2876553000 | 32740966 | 679508 |
| 20 | 1283 | | 3493989000 | 34464282 | 797808 |

In one embodiment, the above exemplary aggregate-level data can be used to determine the weights for the aggregate-level regression model. An example of the results is shown in Table 7 below.

TABLE 7

| Parameter | Value |
|---|---|
| w0 | 0.294972 |
| W1 | 0 |
| w2 | 0.460304 |
| w3 | 0 |
| w4 | 0.298837 |
| alpha1 | 0 |
| alpha2 | 0.62797 |
| alpha3 | 0 |
| beta1 | 0 |
| beta2 | 4.20614 |
| beta3 | 0 |

In one embodiment, the weights may be estimated using standard multiplicative gradient descent, as can be appreciated by a person of ordinary skill in the art.

Other channel weighting models may also be possible. For example, a data-driven instrumental approach to capture true channel weights may include arranging a plurality of channels into different funnel stages, constructing aggregate-level data, and running a multi-stage regression computation on the funnel stages using instrumental variables. For additional details and examples of a data-driven instrumental approach, readers are directed to U.S. Patent Application No. (Attorney Docket No. ADOM1210-1), filed Oct. 17, 2013, entitled “SYSTEM AND METHOD FOR FRACTIONAL ATTRIBUTION UTILIZING AGGREGATED ADVERTISING INFORMATION,” which is fully incorporated by reference herein.

In some embodiments, the conversion rate of each channel may be examined and used to arrange the channels into a funnel of multiple stages. Table 8 below shows an example of different channels arranged by their conversion rates into a funnel with a plurality of funnel stages.

TABLE 8

| Channel/Sub-Channel | Funnel Stage (1 = highest) |
|---|---|
| TV | 1 |
| Brand Display | 2 |
| Retargeting Display | 3 |
| Email | 4 |
| Generic Paid Search | 5 |
| Brand Paid Search | 6 |
| Organic Search | 7 |

For channels for which at least some user-level data exists, attributable conversion rates may be calculated. That is, conversions can be counted if there is at least one touch point from the channel of interest. For channels that do not have user-level data, all the conversions may be used.

In some embodiments, the funnel stage of a given channel can be overridden based on domain knowledge. For example, TV or email can be forced to be at the top of the funnel.

Further, multiple channels may exist at the same funnel stage. For example, Display and TV may be at the same top level.

A channel may be split into sub-channels as needed. For example, one might want to split Retargeting Display and Non-Retargeting display into two different sub-channels as the conversions rates for then can differ by more than one order of magnitude. In addition they are designed to target users at very different of funnel stages. Another example is Branded Search vs. Non-Branded Search—intuitively Branded Search is at a later stage than Non-Branded Search as the users searching for branded keywords are likely already past the awareness stage and in the consideration stage for the particular brand.

Next, aggregate-level data may be constructed for each channel (or sub-channel) as appropriate. For example, user-level data can be aggregated out into aggregate form.

In some embodiments, a multi-stage least squares regression, as an extension of a two-stage least squares algorithm, is run. Multiple regressions may be run in a stepwise fashion as exemplified below:
a. Assume there are m levels, going from 1 to m top down. One may first try to figure out weights for the bottom (m-th) level channels using the standard two-stage least squares algorithm, treating all channels above the m-th level as instrumental variables.
b. After the causal weights of the m-th level channels are determined, do the same for the (m−1)-th level channels, with the residuals as the target (dependent variable) and the channels in the top (m−2) levels as instrumental variables.
c. Repeat this process until the weights are determined for all channels.
d. Optionally, non-negative constraints can be added so that the weights cannot be negative.

For example, the functional form of the model for the example data can be:

y=Σₖ₌₀^{m=3}wₖxₖ

Suppose the following funnel stages used:

TABLE 9

| Channel/Sub-Channel | Funnel Stage (1 = highest) |
|---|---|
| TV | 1 |
| Display | 2 |
| Paid Search | 3 |

The channel weights learned from the example data above can be as follows:

TABLE 10

| Parameter | Value |
|---|---|
| w0 | 0.388314 |
| w1 | 0 |
| w2 | 0.217415 |
| w3 | 0.25 |

A channel weight thus determined may reflect how the key performance indicator will respond to a change to the volume (or advertising spending) of the channel at the aggregate level.

Once channel weights have been determined, an event importance weight may be determined as set forth below:

Let an event E be characterized as

Channel i with weight hᵢ

Attributes {Aⱼ} with probabilities pⱼ=P(C|Aⱼ)

Then the event importance weight can be

$$w ( E ) = {h}_{i} \cdot ( \frac{{\prod }_{j} {p}_{j}}{{\prod }_{j} {p}_{j} + {\prod }_{j} ( 1 - {p}_{j} )} ) \cdot \frac{p ( freq )}{freq}$$

The event importance weight thus determined can then be used in determining the appropriate fraction attribution as described above.

Embodiments can provide many advantages. For example, existing fractional attribution methods rely on marketing mix modeling or marketing mix optimization (MMM/MMO) approaches to deal with scenarios in which user-level data may not be available. Such approaches use regression models on multi-year time-series data to produce relative regression weights for different channels. Such weights are used to explain the contribution from different channels on conversions. They normally stay at the channel level and cannot assign attribution credit at more granular levels. Further, directly normalizing conversion probabilities across different channels may lead to useless results because the probabilities for different channels can differ by orders of magnitudes. To address these issues, embodiments can normalize probabilities by attribute average and leverage aggregate-level models for producing channel-level weights, which are combined with more attribute statistics to generate more granular attribution results. Embodiments can further leverage aggregate-level information on non-converting users to determine granular attribution weights for the touch points on a converting path. Accordingly, embodiments can get aggregate-level attribution results (e.g., total conversions attributed to a channel/campaign) even if some channels may not have any user-level data.

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein (and in particular, the inclusion of any particular embodiment, feature or function within the Abstract or Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Any suitable programming language can be used to implement the routines, methods or programs of embodiments of the invention described herein, including C, C++, Java, assembly language, etc. Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code).

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted.

Furthermore, the term “or” as used herein is generally intended to mean “and/or” unless otherwise indicated. As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise. The scope of the present disclosure should be determined by the following claims and their legal equivalents.

Although the foregoing specification describes specific embodiments, numerous changes in the details of the embodiments disclosed herein and additional embodiments will be apparent to, and may be made by, persons of ordinary skill in the art having reference to this description. In this context, the specification and figures are to be regarded in an illustrative rather than a restrictive sense, and all such modifications are intended to be included within the scope of this disclosure. Accordingly, the scope of the present disclosure should be determined by the following claims and their legal equivalents.

What is claimed is:

1. A method for determining fractional attribution using user-level data and aggregate-level data, comprising:
accessing, by one or more processors, user-level attribution data from a plurality of client devices responsive to ad tags executing on each of the plurality of client devices, the user-level attribution data of each of the plurality of client devices associated with a plurality of event items;
converting, by one or more processors, the user-level attribution data into aggregate attribution data for one or more defined online channels, the aggregate attribution data determined for each of the one or more defined online channels comprising a number of attributable conversions for the each of the one or more defined online channels and a number of impressions for the each of the one or more defined online channels;
determining, by one or more processors, a weight for each of the defined online channels and plurality of offline channels based on the aggregate attribution data for the one or more defined online channels, a number of total number conversions, and a number of impressions for each of the plurality of offline channels;
determining, by one or more processors, marginal conversion probabilities for one or more attributes for each of the one or more defined online channels;
accessing, by one or more processors, a plurality of defined event items for a converting path, each of the plurality of defined event items associated with one or more defined attributes;
determining, by one or more processors, an importance weight for each of the plurality of defined event items based on the determined marginal conversion probabilities for the one or more attributes for each of the one or more defined online channels corresponding to the one or more defined attributes associated with each of the plurality of defined event items and the determined weight for a corresponding defined online channel for the each of the plurality of defined event items; and
normalizing, by one or more processors, the importance weights across the plurality of defined event items of the converting path, the normalized importance weights representing attribution fractions for the converting path.

2. The method according to claim 1, wherein determining the weight for each of the defined online channels and plurality of offline channels comprises a causal analysis with instrumental variables.

3. The method of claim 1, wherein determining the weight for each of the defined online channels and plurality of offline channels comprises:
determining a difference in a number of conversions for a channel of the defined online channels and plurality of offline channels using a predictive model and setting a number of impressions for the channel to zero.

4. The method of claim 1, wherein determining the weight for each of the defined online channels and plurality of offline channels comprises:
generating a predictive model to output a number of predicted conversions based on a number of impressions for each channel of the defined online channels and plurality of offline channels.

5. The method of claim 4, wherein the predictive model is generated using regression modeling.

6. The method of claim 4, wherein the predictive model is generated based on a regression model of:
$${( x + a )}^{n} = {\sum }_{k = 0}^{n} ( \begin{matrix}n \\ k\end{matrix} ) {x}^{k} {a}^{n - k} where$$
$$g ( x ) = \frac{1 - exp ( - x )}{1 + exp ( - x )} ,$$
wherein ŷ is the number of predicted conversions, x₀ is a length of time for the regression model, xₖ is a number of impressions for a channel of m defined online channels and plurality of offline channels, wₖ is the weight for a channel of the defined online channels and plurality of offline channels, wₘ₊₁ is a weighting for channel interactions, αₖ is a channel specific parameter, and βₖ is a channel interaction parameter.

7. The method of claim 1, wherein determining the weight for each of the defined online channels and plurality of offline channels comprises:
determining a funnel stage for each channel of the defined online channels and plurality of offline channels in a plurality of m funnel stages; and
determining a weight for one or more channels at a m funnel stage using multi-stage least squares regression.

8. A computer readable storage device storing instructions that, when executed by one or more processors, cause the one or more processors to perform operations comprising:
accessing user-level attribution data from a plurality of client devices responsive to ad tags executing on each of the plurality of client devices, the user-level attribution data of each of the plurality of client devices associated with a plurality of event items;
converting the user-level attribution data into aggregate attribution data for one or more defined online channels;
determining a weight for each of the defined online channels and plurality of offline channels based on the aggregate attribution data for the one or more defined online channels, a number of total number conversions, and a number of impressions for each of the plurality of offline channels;
determining marginal conversion probabilities for one or more attributes for each of the defined online channels and plurality of offline channels;
accessing a plurality of defined event items for a converting path;
determining an importance weight for each of the plurality of defined event items using the determined marginal conversion probabilities for the one or more attributes for each of the one or more defined online channels and the determined weights for each of the defined online channels; and
normalizing the importance weights across the plurality of event items of the converting path, the normalized importance weights representing attribution fractions for the converting path.

9. The computer readable storage device of claim 8, wherein determining the weight for each of the defined online channels and plurality of offline channels comprises a causal analysis with instrumental variables.

10. The computer readable storage device of claim 8, wherein determining the weight for each of the defined online channels and plurality of offline channels comprises:
determining a difference in a number of conversions for a channel of the defined online channels and plurality of offline channels using a predictive model and setting a number of impressions for the channel to zero.

11. The computer readable storage device of claim 8, wherein determining the weight for each of the defined online channels and plurality of offline channels comprises:
generating a predictive model to output a number of predicted conversions based on a number of impressions for each channel of the defined online channels and plurality of offline channels.

12. The computer readable storage device of claim 11, wherein the predictive model is generated using regression modeling.

13. The computer readable storage device of claim 11, wherein the predictive model is generated based on a regression model of:
$${( x + a )}^{n} = {\sum }_{k = 0}^{n} ( \begin{matrix}n \\ k\end{matrix} ) {x}^{k} {a}^{n - k} where$$
$$g ( x ) = \frac{1 - exp ( - x )}{1 + exp ( - x )} ,$$
wherein ŷ is the number of predicted conversions, x₀ is a length of time for the regression model, xₖ is a number of impressions for a channel of m defined online channels and plurality of offline channels, wₖ is the weight for a channel of the defined online channels and plurality of offline channels, wₘ₊₁ is a weighting for channel interactions, αₖ is a channel specific parameter, and βₖ is a channel interaction parameter.

14. The computer readable storage device of claim 8, wherein determining the weight for each of the defined online channels and plurality of offline channels comprises:
determining a funnel stage for each channel of the defined online channels and plurality of offline channels in a plurality of m funnel stages; and
determining a weight for one or more channels at a m funnel stage using multi-stage least squares regression.

15. A system, comprising:
one or more processors; and one or more storage devices storing instructions that, when executed by the one or more processors, cause the one or more processors to perform operations comprising:
accessing user-level attribution data from a plurality of client devices responsive to ad tags executing on each of the plurality of client devices, the user-level attribution data of each of the plurality of client devices associated with a plurality of event items;
converting the user-level attribution data into aggregate attribution data for one or more defined online channels;
determining a weight for each of the defined online channels and plurality of offline channels based on the aggregate attribution data for the one or more defined online channels, a number of total number conversions, and a number of impressions for each of the plurality of offline channels;
determining marginal conversion probabilities for one or more attributes for each of the defined online channels and plurality of offline channels;
determining an importance weight for a defined touch point using the determined marginal conversion probabilities for the one or more attributes for each of the defined online channels and plurality of offline channels and the determined weights for each of the defined online channels and plurality of offline channels; and
normalizing the importance weights across a plurality of touch points, the normalized importance weights representing an attribution fraction for the defined touch point.

16. The system of claim 15, wherein determining the weight for each of the defined online channels and plurality of offline channels comprises a causal analysis with instrumental variables.

17. The system of claim 15, wherein determining the weight for each of the defined online channels and plurality of offline channels comprises:
determining a difference in a number of conversions for a channel of the defined online channels and plurality of offline channels using a predictive model and setting a number of impressions for the channel to zero.

18. The system of claim 15, wherein determining the weight for each of the defined online channels and plurality of offline channels comprises:
generating a predictive model to output a number of predicted conversions based on a number of impressions for each channel of the defined online channels and plurality of offline channels.

19. The system of claim 18, wherein the predictive model is generated based on a regression model of:
$${( x + a )}^{n} = {\sum }_{k = 0}^{n} ( \begin{matrix}n \\ k\end{matrix} ) {x}^{k} {a}^{n - k} where$$
$$g ( x ) = \frac{1 - exp ( - x )}{1 + exp ( - x )} ,$$
wherein ŷ is the number of predicted conversions, x₀ is a length of time for the regression model, xₖ is a number of impressions for a channel of m defined online channels and plurality of offline channels, wₖ is the weight for a channel of the defined online channels and plurality of offline channels, wₘ₊₁ is a weighting for channel interactions, αₖ is a channel specific parameter, and βₖ is a channel interaction parameter.

20. The system of claim 15, wherein determining the weight for each of the defined online channels and plurality of offline channels comprises:
determining a funnel stage for each channel of the defined online channels and plurality of offline channels in a plurality of m funnel stages; and
determining a weight for one or more channels at a m funnel stage using multi-stage least squares regression.
